(19) United States
(12) Patent Application Publication
(10) Pub. No.: US 2026/0169333 A1
(43) Pub. Date: Jun. 18, 2026

(54) DISPLAY PANEL

(71) Applicant: Wuhan China Star Optoelectronics Technology Co., Ltd., Wuhan, Hubei (CN)

(72) Inventors: Wenqiang YU, Wuhan, Hubei (CN); Chao WANG, Wuhan, Hubei (CN)

(73) Assignee: Wuhan China Star Optoelectronics Technology Co., Ltd., Wuhan, Hubei (CN)

(21) Appl. No.: 18/850,597

(22) PCT Filed: Nov. 23, 2023
(86) PCT No.: PCT/CN2023/133720

§ 371 Date: Sep. 25, 2024

(30) Foreign Application Priority Data
Oct. 9, 2023 (CN) 202311304343.2

(51) Int. Cl. G02F 1/1362; G02F 1/1333; G02F 1/1368

(52) U.S. Cl. CPC G02F 1/136209; G02F 1/133345; G02F 1/133357; G02F 1/136222; G02F 1/1368

(57) ABSTRACT

The present disclosure provides a display panel including a thin film transistor array substrate, a liquid crystal layer, and an opposing substrate; The thin film transistor array substrate includes: a color film layer disposed on a control device layer, the color film layer including a plurality of color resist portions of different colors; a pixel electrode disposed between the first planarization layer and the first passivation layer; a first common electrode disposed on the first passivation layer; and a first light blocking layer disposed on a surface of the first common electrode close to or away from the opposing substrate, the first light blocking layer covers at least an overlapping portion of two adjacent ones of the plurality of color resist portions having different colors and partially overlapping each other.

The present disclosure claims priority to Chinese Patent Application No. 202311304343.2, filed Oct. 9, 2023, the entire contents of which are incorporated herein by reference.

### TECHNICAL FIELD

The present disclosure relates to a field of display technologies, and more particularly, to a display panel.

### BACKGROUND

A liquid crystal display panel is generally formed by combining a thin film transistor array substrate and a color film substrate. In the manufacturing process thereof, the thin film transistor array substrate and the color film substrate need to be accurately combined (aligned), and the requirement for accuracy of the alignment is increased as the pixel density is increased.

For a display panel of a mobile phone or a flat panel display product, the accuracy of the alignment is generally about 2 microns. However, for a display panel of a virtual reality (VR) product, since a pixel pitch is less, the requirement for accuracy of the alignment is higher, and therefore, a greater alignment error may easily occur.

An excessive alignment error may easily cause a serious product yield problem.

### SUMMARY

The display panel according to an embodiment of the present disclosure is intended to solve the serious product yield problem caused by excessive alignment error.

To solve the above problem, the technical solution of an embodiment of the present disclosure is as follows:

In a first aspect, the present disclosure provides a display panel including a thin film transistor array substrate, a liquid crystal layer, and an opposing substrate, wherein the liquid crystal layer is disposed between the thin film transistor array substrate and the opposing substrate; the thin film transistor array substrate comprises: a control device layer including a plurality of control devices; a color film layer disposed on the control device layer, wherein the color film layer includes a plurality of color resist portions of different colors, and two adjacent ones of the plurality of color resist portions having different colors partially overlap each other; a first planarization layer disposed on a surface of the color film layer close to the opposing substrate; a first passivation layer disposed on the first planarization layer; a pixel electrode disposed between the first planarization layer and the first passivation layer; a first common electrode disposed on the first passivation layer; and a first light blocking layer disposed on a surface of the first common electrode close to or away from the opposing substrate, wherein the first light blocking layer covers at least an overlapping portion of two adjacent ones of the plurality of color resist portions having different colors and partially overlapping each other.

In a second aspect, the present disclosure provides a display panel including a thin film transistor array substrate, a liquid crystal layer, and an opposing substrate, wherein the liquid crystal layer is disposed between the thin film transistor array substrate and the opposing substrate; the thin film transistor array substrate comprises: a control device layer including a light blocking layer, a buffer layer, a semiconductor layer, a gate insulating layer, a gate, a first interlayer insulating layer, a second interlayer insulating layer, a source and a drain, wherein the buffer layer covers the light blocking layer, the semiconductor layer, the gate insulating layer, the gate, the first interlayer insulating layer and the second interlayer insulating layer are stacked on the buffer layer in this order, the source is disposed on the first interlayer insulating layer, and the drain is disposed on the second interlayer insulating layer; a color film layer disposed on the second interlayer insulating layer and below a first planarization layer, wherein the color film layer includes a plurality of color resist portions of different colors, and two adjacent ones of the plurality of color resist portions having different colors partially overlap each other; the first planarization layer disposed on a surface of the color film layer close to the opposing substrate; a first passivation layer disposed on the first planarization layer; a pixel electrode disposed between the first planarization layer and the first passivation layer; a first common electrode disposed on the first passivation layer; and a first light blocking layer disposed on a surface of the first common electrode close to or away from the opposing substrate, wherein the first light blocking layer covers at least an overlapping portion of two adjacent ones of the plurality of color resist portions having different colors and partially overlapping each other.

### BRIEF DESCRIPTION OF THE DRAWINGS

FIG. 1 is a schematic view of a first embodiment of a display panel according to the present disclosure.

FIG. 2 is a schematic view showing a positional relationship of a color film layer, a first groove and a second groove in the display panel shown in FIG. 1.

FIG. 3 is a schematic view of a second embodiment of a display panel according to the present disclosure.

FIG. 4 is a schematic view showing a positional relationship between a first light blocking layer, a second light blocking layer and a first common electrode in the display panel shown in FIG. 3.

FIG. 5 is a schematic view of a third embodiment of a display panel according to the present disclosure.

FIG. 6 is a schematic view of a fourth embodiment of a display panel according to the present disclosure.

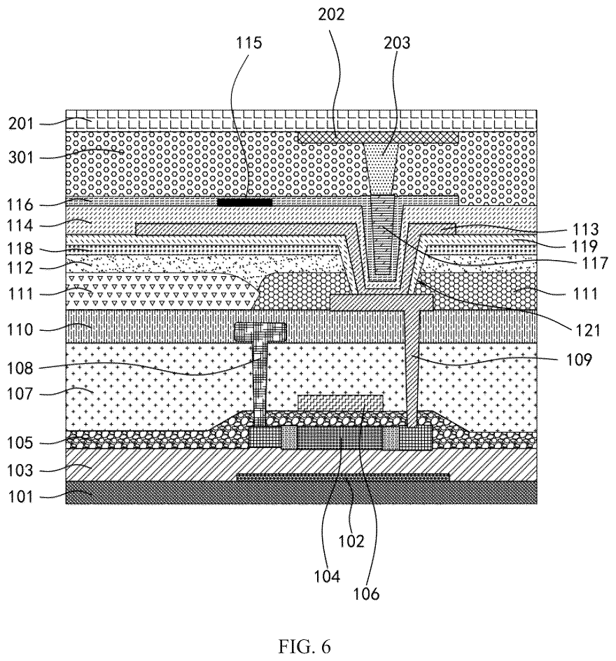

### DETAILED DESCRIPTION

A meaning of a term used in the specification and claims corresponds to that commonly understood by a person having ordinary skill in the art to which the present disclosure belongs. The term used in the specification and claims is for description and understanding of the present disclosure only, and is not intended to limit the present disclosure to the narrow interpretation of the specific terminology used in the specification and claims.

The various embodiments disposed herein are similar, and features in different embodiments may be combined with each other.

Embodiments of the present disclosure are described in detail below in connection with specific embodiments. It should be noted that the following embodiments are merely illustrative of the present disclosure and do not limit the scope of the present disclosure.

An embodiment of the present disclosure provides a display panel including a thin film transistor array substrate, a liquid crystal layer, and an opposing substrate, wherein the liquid crystal layer is disposed between the thin film transistor array substrate and the opposing substrate; the thin film transistor array substrate comprises: a control device layer including a plurality of control devices; a color film layer disposed on the control device layer, wherein the color film layer includes a plurality of color resist portions of different colors, and two adjacent ones of the plurality of color resist portions having different colors partially overlap each other; a first planarization layer disposed on a surface of the color film layer close to the opposing substrate; a first passivation layer disposed on the first planarization layer; a pixel electrode disposed between the first planarization layer and the first passivation layer; a first common electrode disposed on the first passivation layer; and a first light blocking layer disposed on a surface of the first common electrode close to or away from the opposing substrate, wherein the first light blocking layer covers at least an overlapping portion of two adjacent ones of the plurality of color resist portions having different colors and partially overlapping each other.

In the display panel of the present disclosure, a second light blocking layer is disposed in the opposing substrate, and a light blocking range of the first light blocking layer is different from a light blocking range of the second light blocking layer.

In the display panel of the present disclosure, the control device layer further comprises a plurality of gate lines, the first light blocking layer comprises a plurality of first light blocking strips parallel to each other, and a length direction of the first light blocking strip is perpendicular to a length direction of the gate lines; and; the second light blocking layer includes a plurality of second light blocking strips parallel to each other, and a length direction of the second light blocking strip is parallel to the length direction of the gate line.

In the display panel of the present disclosure, a width of the first light blocking strip is less than a width of the second light blocking strip.

In the display panel of the present disclosure, an edge of the color resist portion is located within a light blocking range of the first light blocking strip, and the gate line is located within a light blocking range of the second light blocking strip.

In the display panel of the present disclosure, in a direction perpendicular to the length direction of the gate line, a first groove is disposed between two adjacent ones of the plurality of color resist portions, and a length direction of the first groove is parallel to the length direction of the gate line; a second groove is disposed at the first planarization layer, and the second groove is sleeved within the first groove; a portion of the pixel electrode disposed in the first groove and electrically connected to the control device; and a portion of the first passivation layer is disposed on a surface of the portion of the pixel electrode located in the first groove.

In the display panel of the present disclosure, a second common electrode and a second passivation layer are disposed between the first planarization layer and the first passivation layer, the second common electrode is disposed on the first planarization layer, a portion of the second passivation layer is disposed between the second common electrode and the pixel electrode, and another portion of the second passivation layer is disposed between the second common electrode and the first passivation layer; and wherein the second common electrode and the second passivation layer are disconnected at the first groove.

In the display panel of the present disclosure, a portion of the first common electrode is disposed in the second groove; the thin film transistor array substrate further includes a second planarization layer, and a portion of the second planarization layer is disposed on a portion of the first common electrode located in the second groove; and a support member is disposed on a surface of the opposing substrate close to the thin film transistor array substrate, and an end of the support member away from the opposing substrate is in contact with the second planarization layer.

In the display panel of the present disclosure, the first light blocking layer has a thickness of 700 angstroms to 2,000 angstroms and the second light blocking layer has a thickness of 10,000 angstroms to 30,000 angstroms.

In the display panel of the present disclosure, the first light blocking layer is one of a metal layer and a metal oxide layer or a laminated layer formed by laminating the metal layer and the metal oxide layer, and the second light blocking layer is a resin layer.

In the display panel according to an embodiment of the present disclosure, the color film layer and the light blocking layer are transferred to the thin film transistor array substrate, so that a problem that the display panel with the high pixel density in the prior art has a lower yield rate and a relatively serious color shift of the display panel at a greater viewing angle due to a greater alignment accuracy error may be effectively solved. In the display panel according to an embodiment of the present disclosure, first, the color film layer and the first light blocking layer are transferred to the thin film transistor array substrate, so that the color film layer and the first light blocking layer may be formed in a self-alignment in the same platform. Compared with a solution of aligning the thin film transistor array substrate with the color film substrate disposed with the color film layer in the related art, alignment accuracy may be greatly improved. Meanwhile, the color film layer and the first light blocking layer are transferred to the thin film transistor array substrate, so that the effect of alignment errors between the thin film transistor array substrate and the opposing substrate in the length direction of the gate line on product yield may be eliminated, thereby improving the product yield. Secondly, since the accuracy of the size of the element including a metal or a metal oxide formed by the photomask process and the etching process is greater than the accuracy of the size of the element including a resin formed by the photomask process and the etching process, in an embodiment of the present disclosure, the first light blocking layer is made of a metal or a metal oxide material, so that the shape and the size of the first light blocking layer may be more conformed to the shape and the size of the light-transmitting hole of the mask plate, the line width of the first light blocking layer is less, and the line width uniformity is improved, thereby making the opening of the pixel greater, thereby improving the aperture ratio and improving the display quality of the display panel. In addition, by transferring the color film layer and the first light blocking layer to the thin film transistor array substrate, so that the optical path difference that the light rays pass through the display panel at different viewing angles may be reduced, the color shift at a greater viewing angle may be reduced, and the viewing angle range may be expanded. Finally, since the gate line is shielded by the second light blocking layer, dark regions caused by the electric field region of the gate line may be prevented.

The present disclosure is an improvement for display panels of virtual reality (VR) products with high pixels per inch (PPI, number of pixels per inch).

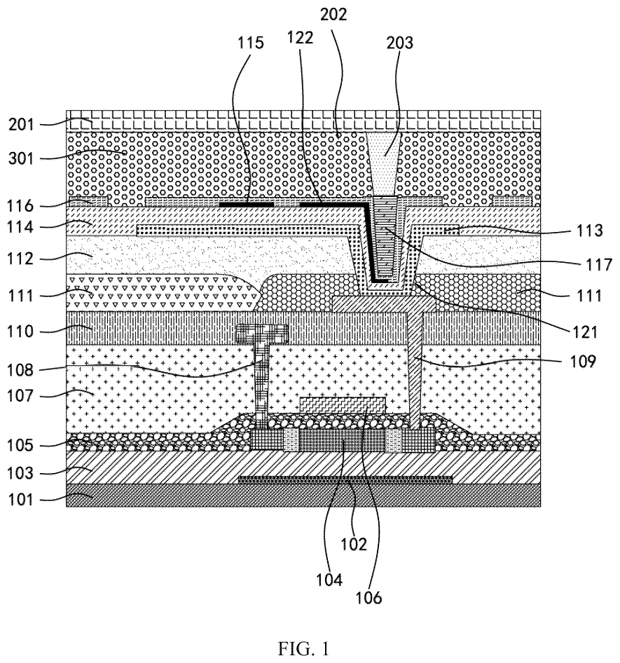

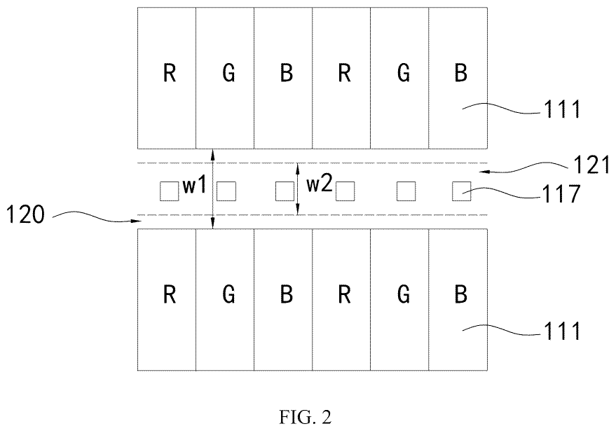

As shown in FIGS. 1 and 2, in a display panel according to a first embodiment of the present disclosure, the display panel includes a liquid crystal display panel including a thin film transistor array substrate, a liquid crystal layer 301, and an opposing substrate 101. The thin film transistor array substrate and the opposing substrate are coupled into an integral body, and the liquid crystal layer is disposed between the thin film transistor array substrate and the opposing substrate. The liquid crystal layer includes liquid crystal molecules.

In an embodiment, the color film layer 111 and the first light blocking layer of the display panel are disposed in the thin film transistor array substrate.

The thin film transistor array substrate includes a first substrate 101, a light blocking layer 102, a buffer layer 103, a semiconductor layer 104, a gate insulating layer 105, a gate 106, a first interlayer insulating layer 107, a second interlayer insulating layer 110, a source 108, a drain 109, a color film layer 111, a first planarization layer 112, a pixel electrode 113, a first passivation layer 114, a first common electrode 116, a first light blocking layer (metal light blocking layer), and a second planarization layer 117. The light blocking layer 102, the buffer layer 103, the semiconductor layer 104, the gate insulating layer 105, the gate 106, the first interlayer insulating layer 107, the second interlayer insulating layer 110, the source 108, and the drain 109 constitute a control device layer including a plurality of control devices. The control devices may include, for example, one or more thin film transistors each including a gate, a source, and a drain.

In the thin film transistor array substrate, the light blocking layer 102 is disposed on the first substrate 101. The buffer layer 103 is disposed on the first substrate 101 and covers the light blocking layer 102. The semiconductor layer 104 is disposed on the buffer layer 103. The semiconductor layer 104 is located within the light blocking range of the light blocking layer 102. The gate insulating layer 105 is disposed on the buffer layer 103 and covers the semiconductor layer 104. The gate 106 is disposed on the gate insulating layer 105. The first interlayer insulating layer 107 is disposed on the gate insulating layer 105 and covers the gate 106. The source 108 is disposed on the first interlayer insulating layer 107. The second interlayer insulating layer 110 is disposed on the first interlayer insulating layer 107 and covers the source 108. The drain 109 is disposed on the second interlayer insulating layer 110.

In an embodiment of the present disclosure, the color film layer 111 is disposed on the control device layer. For example, the color film layer 111 is disposed on the second interlayer insulating layer 110, and is disposed below the first planarization layer 112. The color film layer 111 is made of a less-film-thickness high-color-gamut material, so that the cell thickness of the liquid crystal cell may be reduced, the path through which light is to pass may be reduced, and the optical path difference may be reduced. The color film layer 111 has an island-shaped shape, and the color film layer 111 includes a plurality of (island-shaped) color resist portions of different colors, and two adjacent color resist portions of different colors partially overlap at the overlapping portion of the two color resist portions. The overlapping portions of the color film layer 111 at which two adjacent ones of the color resist portions partially overlap each other are located within the light blocking range of the first light blocking layer.

The first planarization layer 112 is disposed on the color film layer 111. In an embodiment, the first planarization layer 112 is disposed on a surface of the color film layer 111 close to the opposing substrate, the first planarization layer 112 covers the color film layer 111, and the difference in the film thickness of the color film layer 111 is partially filled and planarized by the first planarization layer 112, that is, the first planarization layer 112 fills the concave at the overlapping portion (partially overlapped portion) of the color film layer 111 to reduce the influence of the uneven surface (concave) of the color film layer 111 on the image quality.

The first passivation layer 114 is disposed on the first planarization layer 112 and covers the pixel electrode 113.

The pixel electrode 113 is disposed between the first planarization layer 112 and the first passivation layer 114, and a part of the pixel electrode is disposed in the first groove and electrically connected to the control device, that is, the pixel electrode 113 is connected to the drain 109 in the thin film transistor array substrate.

The first common electrode 116 is disposed on the first passivation layer 114, a portion of the first common electrode 116 is located above a portion of the pixel electrode 113. The first common electrode 116 overlaps the pixel electrode 113, that is, a capacitor is formed by the first common electrode 116 and the pixel electrode 113. The materials of the first common electrode 116 and the pixel electrode 113 includes an indium tin oxide (ITO).

The first light blocking layer is disposed above or below the first common electrode 116. In an embodiment, the first light blocking layer is disposed on a surface of the first common electrode close to or away from the opposing substrate. For example, the first light blocking layer is disposed on a surface of the first passivation layer 114, the first common electrode 116 covers the first light blocking layer, and an insulating layer is disposed between the first light blocking layer and the first common electrode 116. Alternatively, the first light blocking layer is disposed on the first common electrode 116, and an insulating layer is disposed between the first light blocking layer and the first common electrode 116. The first light blocking layer covers at least the overlapping portion of the two adjacent color resist portions of different colors where the two adjacent color resist portions partially overlap each other.

The first light blocking layer includes a plurality of first light blocking strips 115 parallel to each other and a plurality of second light blocking strips 122 parallel to each other. The overlapping portion of the adjacent two color resist portions partially overlapping are located within the light blocking range of the first light blocking strip 115, that is, edges of the color resist portions are located within the light blocking range of the first light blocking strip, and the gate lines are located within the light blocking range of the second light blocking strip 122. A length direction of the first light blocking strip 115 is perpendicular to a length direction of the gate line of the control device layer, and a length direction of the second light blocking strip 122 is parallel to a length direction of the gate line. The first light blocking layer has a thickness of 700 angstroms to 2,000 angstroms, to prevent the surface of the thin-film transistor array substrate from being not smooth due to the excessive thickness of the first light blocking layer, thereby causing the occurrence of the dark region of the liquid crystal. The first light blocking layer is one of a metal layer and a metal oxide layer or a laminated layer formed by laminating the metal layer and the metal oxide layer, that is, the first light blocking layer film layer may be a metal layer, a metal oxide layer, or a composite laminated layer formed by laminating the metal layer and the metal oxide layer.

The width of the first light blocking strip is less than the width of the second light blocking strip.

The metal may include, for example, at least one of chromium, aluminum, silver, or the like. The metal oxide may include, for example, chromium oxide (Chromium Oxide, CrOx), aluminum oxide (Aluminum Oxide, AlOx), titanium nitride (Titanium Nitride, TiN), titanium oxide (Titanium Oxide, TiOx), silver oxide (Silver Oxide, Ag2O), or nickel oxide (Nickel Oxide, NiO). The first light blocking layer is made by forming a light blocking metal layer by evaporation or sputtering, and then performing pattern etching on the light blocking metal layer to obtain a desired light blocking shape.

A groove is disposed at each of the color film layer and the first planarization layer, the groove penetrates through the color film layer and the first planarization layer, a length direction of the groove is parallel to the length direction of the gate line, and the groove is located in the light blocking range of the second light blocking strip 122. The groove includes a first groove 121 and a second groove 120.

The first groove 121 is disposed on the color film layer 111. In a direction perpendicular to the length direction of the gate lines of the thin film transistor array substrate, the first groove is between two adjacent color resist portions. A length direction of the first groove is parallel to the length direction of the gate line. The first groove 121 has a width w2 of 2 microns to 6 microns. For example, the first groove 121 has a width w2 of 2 microns, 2.2 microns, 2.4 microns, 2.6 microns, 2.8 microns, 3 microns, 3.2 microns, 3.4 microns, 3.6 microns, 3.8 microns, 4 microns, 4.2 microns, 4.4 microns, 4.6 microns, 4.8 microns, 5 microns, 5.2 microns, 5.4 microns, 5.6 microns, 5.8 microns, 6 microns. A spacing between two adjacent color resist portions separated by the first groove 121 is in a range from 2 microns to 6 microns. For example, the spacing is 2 microns, 2.2 microns, 2.4 microns, 2.6 microns, 2.8 microns, 3 microns, 3.2 microns, 3.4 microns, 3.6 microns, 3.8 microns, 4 microns, 4.2 microns, 4.4 microns, 4.6 microns, 4.8 microns, 5 microns, 5.2 microns, 5.4 microns, 5.6 microns, 5.8 microns, or 6 microns.

A through-hole opening method is generally adopted in a conventional display panel in a vertical alignment (VA) mode, because of sufficient space thereof. However, for a display panel for a VR product, the through-hole opening method is not practical in view of the limitation of material and equipment processing capability. Therefore, the color film layer 111 of the present disclosure adopts a lateral disconnection design, that is, the color film layer 111 is disposed in an island shape. In an embodiment, the spacing between the color resist portions of the island shape in the color film layer 111 is controlled to be in a range of 4 microns to 5 microns.

The second groove 120 is disposed on the first planarization layer 112. In an embodiment, the first planarization layer 112 is disposed with the second groove 120 in the length direction of the gate line, and the second groove 120 overlaps with the first groove 121, that is, the second groove is sleeved within the first groove. The second groove 120 of the first planarization layer 112 is nested within the first groove 121 of the color film layer 111, that is, the second groove 120 penetrating the first planarization layer 112 is located in the first groove 121 penetrating the color film layer 111. The second groove 120 has a width w1 of 1.6 microns to 6.4 microns. For example, the second groove 120 has a width w1 of 1.6 microns, 1.8 microns, 2.0 microns, 2.2 microns, 2.4 microns, 2.6 microns, 2.8 microns, 3 microns, 3.2 microns, 3.4 microns, 3.6 microns, 3.8 microns, 4 microns, 4.2 microns, 4.4 microns, 4.6 microns, 4.8 microns, 5 microns, 5.2 microns, 5.4 microns, 5.6 microns, 5.8 microns, 6.0 microns, 6.2 microns, 6.4 microns.

The length direction of the first groove 121 is parallel to the length direction of the second light blocking strip 122. The first groove 121 and the second groove 120 are located within the light blocking range of the second light blocking strip 122, and the length direction of the second groove 120 is parallel to the length direction of the first groove 121.

A portion of the first passivation layer 114 is disposed on a portion of the pixel electrode in the groove, that is, the portion of the first passivation layer 114 is disposed on a surface of a portion of the pixel electrode 113 in the first groove 121. A portion of the first common electrode is disposed in the second groove. A first concave portion is disposed at a portion of the first passivation layer 114 disposed in the first groove 121/in the second groove 120e. A portion of the first common electrode 116 is disposed on a portion of the first passivation layer 114 located in the groove, that is, the portion of the first common electrode 116 is disposed in the first concave portion, the portion of the first common electrode 116 disposed in the first concave portion is disposed with a second concave portion, and the second planarization layer 117 is disposed in the second concave portion, that is, a portion of the second planarization layer is disposed on a portion of the first common electrode located in the second groove.

In the display panel of the VR product, the second planarization layer 117 fills the discontinuities (the first groove 121 and the second groove 120) of the color film layer 111 and the first planarization layer 112 to facilitate liquid crystal efficiency and the stance of the support 203.

A part of the pixel electrode is electrically connected to the source in the control device layer exposed in the groove, that is, the pixel electrode 113 is connected to the drain 109 in the thin film transistor array substrate through the second groove 120 of the first planarization layer 112 and the first groove 121 of the color film layer 111. In an embodiment, a portion of the pixel electrode 113 is disposed in the first groove 121, and the portion of the pixel electrode 113 disposed in the first groove 121 is connected to the drain 109. The pixel electrode 113 is connected to the drain 109 through the first groove 121 and the second groove 120, which is nested in the first groove 121, of the first planarization layer 112 and the color film layer 111.

The second planarization layer 117 is disposed on a portion of the first common electrode 116 located in the groove, that is, the second planarization layer 117 is disposed on the second concave portion of the first common electrode 116 located in the first groove 121.

At least a portion of the second light blocking strip 122 is located below a portion of the first common electrode 116 disposed in the groove, or at least a portion of the light blocking strip 122 is disposed on the second planarization layer 117.

A support member is disposed on a surface of the opposing substrate close to the thin film transistor array substrate, and an end of the support member away from the opposing substrate is in contact with the second planarization layer, that is, the opposing substrate includes a second substrate 201 and a support member 203, the support member 203 is disposed on the second substrate 201, and an end of the support member 203 away from the second substrate 201 is in contact with the second planarization layer 117.

In the present disclosure, the color film layer 111 and the first light blocking layer in the opposing substrate may also be transferred into the thin film transistor array substrate. The first light blocking layer is disposed in the vicinity of (above or below) the first common electrode 116, and the first light blocking layer is configured to shield the overlapping portions of two adjacent ones of the color resist portions partially overlap each other at the intersection thereof and a phenomenon of color shift of the adjacent two color film layers 111. The material of the first light blocking layer includes a metal and/or a metal oxide.

Since the first light blocking strip 115 with the length direction perpendicular to the length direction of the gate line of the control device layer and the second light blocking strip 122 with the length direction parallel to the length direction of the gate line are disposed are the thin film transistor array substrate, and the first light blocking strip 115 and the second light blocking strip 122 are both made of metal and/or metal oxide, the first light blocking strip 115 and the second light blocking strip 122 may be directly used to shield the overlapping portions of two adjacent ones of the color resist portions partially overlap each other at the intersection thereof and the gate line of the thin film transistor array substrate, to effectively improve the accuracy of shielding of the first light blocking strip 115 and the second light blocking strip 122 on the overlapping portions of two adjacent ones of the color resist portions partially overlap each other at the intersection thereof and the gate line of the thin film transistor array substrate, and to avoid serious product yield problems caused by alignment errors between the thin film transistor array substrate and the opposing substrate.

Since the first light blocking layer is made of metal and/or metal oxide, the line width of the first light blocking layer may be made less, the line width uniformity may be improved, and the improvement of the opening rate of the display panel and the display quality may be greatly facilitated.

The color shift of the display panel at a greater viewing angle is strongly correlated with a first light blocking layer located in the opposing substrate. However, in an embodiment of the present disclosure, there is a significant improvement in the color shift because the first light blocking layer and the color film layer 111 are disposed in the thin film transistor array substrate, the color bias may be greatly improved.

Since both the color film layer 111 and the first light blocking layer are disposed in the thin film transistor array substrate, the color film layer 111 and the first light blocking layer are formed in a self-aligning process in the same platform, and the alignment accuracy is greatly improved compared with the conventional alignment accuracy of the thin film transistor array substrate and the color film substrate disposed with the color film layer 111. That is, since the color film layer 111 and the first light blocking layer are both formed in the same platform, the influence of alignment misalignment between the thin film transistor array substrate and the color film substrate may be avoided, and the process accuracy and the product yield may be improved.

Since the first light blocking layer is disposed in the thin film transistor array substrate and the material of the first light blocking layer includes metal and/or metal oxide, the line width of the first light blocking layer may be made less and more accurate, and therefore the aperture ratio of the pixels of the display panel may be improved.

The color shift of the display panel at a greater viewing angle is strongly correlated with a first light blocking layer located in the color film substrate. However, in an embodiment of the present disclosure, since the first light blocking layer and the color film layer 111 are disposed in the thin film transistor array substrate. Therefore, the color film substrate is formed by a thinner material to effectively reduce the optical path difference, thereby improving the color shift at a greater viewing angle and reducing the risk of the color shift at a greater viewing angle.

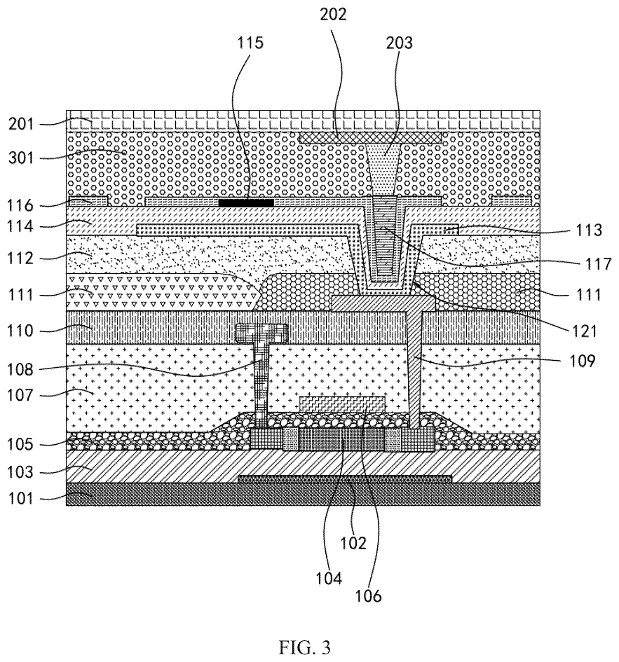

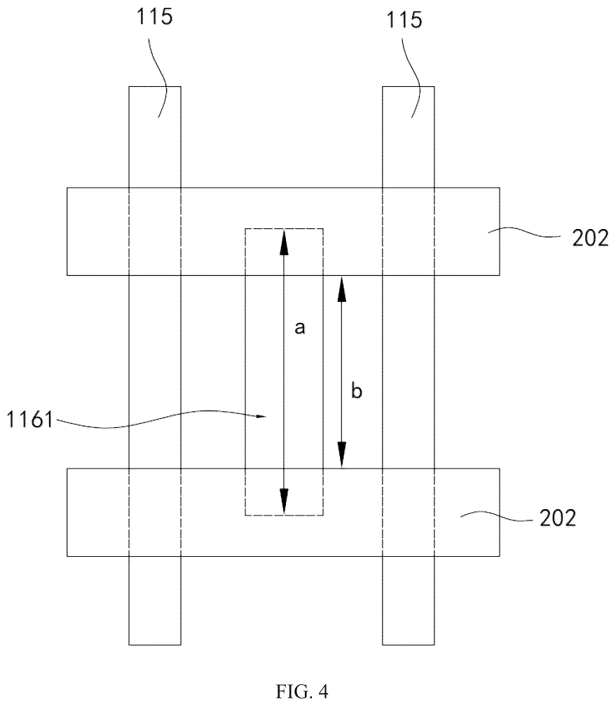

As shown in FIGS. 3 and 4, the display panel in a second embodiment of the present disclosure is similar to that in the first embodiment described above, except that:

the second light blocking layer is disposed in the opposing substrate, that is, a color film layer 111 and the first light blocking layer of the display panel are disposed in the thin film transistor array substrate, and the second light blocking layer 202 of the display panel is disposed in the opposing substrate. The light blocking range of the first light blocking layer is different from the light blocking range of the second light blocking layer. For example, the light blocking range of the first light blocking layer is outside the light blocking range of the second light blocking layer.

Since the display panel of the VR product adopts the structure in which the common electrode is located on the pixel electrode 113, the end portion of the gap 1161 of the common electrode is prevented from being shielded by the second light blocking layer 202 and the end portion of the gap 1161 of the common electrode is prevented from being shielded, the gap 1161 of the common electrode is prevented from being reduced indirectly from a to b, and a loss of the penetration rate of the display panel of the VR product may be avoided. In the present embodiment, the second light blocking layer 202 is disposed in the opposing substrate in the length direction of the gate line, and is made of resin, so that the end portion of the gap 1161 of the common electrode is not shielded, and the gap 1161 of the common electrode still has a length of a.

The opposing substrate includes a second substrate 201, a second light blocking layer 202 (a resin light blocking layer), and a support 203. In the opposing substrate, the second light blocking layer 202 is disposed on the second substrate 201, the support 203 is disposed on the second light blocking layer 202, and an end of the support 203 close to the second substrate 201 is in contact with the second light blocking layer 202. The second light blocking layer is a resin layer, and the second light blocking layer 202 is made of a conventional resin, and the thickness of the second light blocking layer 202 is greater than or equal to the thickness of the first light blocking layer. In an embodiment, the second light blocking layer 202 has a thickness of 10,000 angstroms to 30,000 angstroms, for example, 10,000 angstroms, 12,000 angstroms, 14,000 angstroms, 16,000 angstroms, 18,000 angstroms, 20,000 angstroms, 22,000 angstroms, 24,000 angstroms, 26,000 angstroms, 28,000 angstroms, or 30,000 angstroms.

The first light blocking layer includes at least two third light blocking strips, and portions of the adjacent two color-blocking portions partially overlapping are located within a light blocking range of the third light blocking strips. The length direction of the third light blocking strip is perpendicular to the length direction of the gate line of the control device layer.

The second light blocking layer 202 is configured to shield electric field dark regions, metal traces, and the like of the display panel in the length direction of the gate line. The gate lines in the thin film transistor array substrate are located within the light blocking range of the second light blocking layer 202. In an embodiment, the second light blocking layer includes at least two fourth light blocking strips, and a gate line of the control device layer is located in a light blocking range of the fourth light blocking strip. The length direction of the fourth light blocking strip is parallel to the length direction of the gate line.

The groove is located in the shading range of the fourth shading strip. The length direction of the first groove 121 is parallel to the length direction of the second light blocking layer 202. The first groove 121 and the second groove 120 are located within the light blocking range of the second light blocking layer 202, and the length direction of the second groove 120 is parallel to the length direction of the first groove 121.

As shown in FIG. 3, in the present embodiment, at least a portion of the first light blocking layer is elongated, a straight line corresponding to the elongated portion of the first light blocking layer is perpendicular to the length direction of the gate line, at least a portion of the second light blocking layer 202 is elongated, and a straight line corresponding to the elongated portion of the second light blocking layer 202 is parallel to the length direction of the gate line. For example, the first light blocking strip 115 is elongated and extends in a direction perpendicular to the length direction of the gate line, and the second light blocking strip 122 is elongated and extends in the length direction of the gate line.

Since the second light blocking strip 122 is transferred to the opposing substrate and made of resin, the second light blocking strip 122 made of resin does not shield the electric field region of the common electrode.

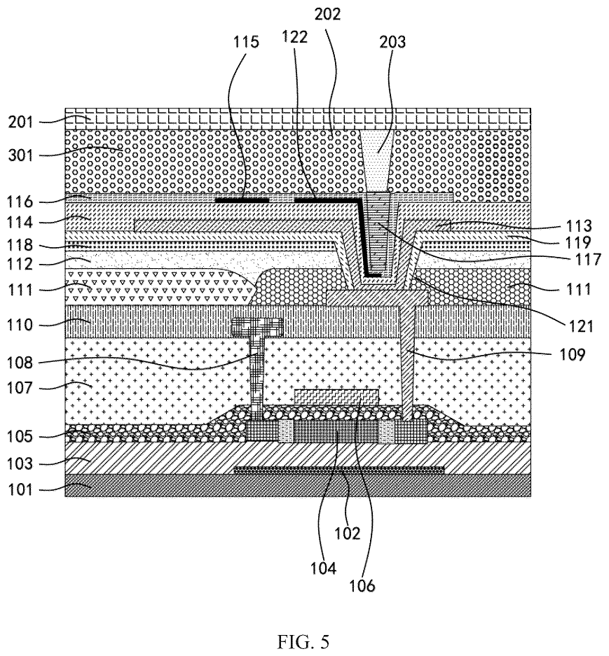

As shown in FIG. 5, the display panel according to a third embodiment of the present disclosure is similar to that in the first embodiment described above, and the display panel according to a fourth embodiment is similar to that in the second embodiment, except that:

a second common electrode 118 and a second passivation layer 119 are disposed between the first planarization layer and the first passivation layer, the second common electrode 118 is disposed on the first planarization layer 112, a portion of the second passivation layer 119 is disposed between the second common electrode 118 and the pixel electrode 113, and another portion of the second passivation layer 119 is disposed between the second common electrode 118 and the first passivation layer 114.

That is, the display panel further includes the second common electrode 118 disposed on the first planarization layer 112 and the second passivation layer 119 disposed on the second common electrode 118. The pixel electrode 113 is disposed on the second passivation layer 119, the first passivation layer 114 is disposed on the second passivation layer 119, and the first passivation layer 114 covers the pixel electrode 113. The first common electrode 116 is disposed on the first passivation layer 114. Since the pixel electrode 113 is disposed between the first common electrode 116 and the second common electrode 118, the capacitance value of the capacitor formed by the pixel electrode 113 and the common electrode may be increased.

The second common electrode 118 and the second passivation layer 119 are disconnected at the first groove.

The material of the second common electrode 118 includes indium tin oxide (ITO).

In an embodiment, a metal bridge is disposed between the first common electrode 116 and the second common electrode 118. The metal bridge includes ITO, and the cross-sectional areas of the metal bridge located in different regions of the display panel are different.

In an embodiment, a switching transistor is disposed in the display panel. A source of the switching transistor is connected to a regulated voltage output terminal (for example, a terminal of the data line). A drain of the switching transistor is connected to the first common electrode 116 or the second common electrode 118. A gate of the switching transistor is connected to a control signal output terminal. A capacitive coupling effect between the first common electrode and the second common electrode is adjusted by controlling a turn-on/off state of the switching transistor, so that a response speed of liquid crystal molecules of the liquid crystal layer may be improved.

In an embodiment, a plurality of micropores are disposed in the first common electrode 116 and the second common electrode 118 by means of laser drilling. The capacitive coupling effect between the first common electrode 116 and the second common electrode 118 is controlled by adjusting the diameter and density of each of the micropores, thereby optimizing the charge uniformity of the display panel and the response speed of the liquid crystal molecules. The micropore has a diameter of 0.5 microns to 2 microns, for example, the micropore has a diameter of 0.5 microns, 0.7 microns, 0.9 microns, 1.1 microns, 1.3 microns, 1.5 microns, 1.7 microns, 1.9microns, 2.0 microns, so that the capacitive coupling may be generated a certain degree to accelerate the response speed of the local liquid crystal while meeting the requirements of rapid and uniform charging of the pixels.

Since the gate line is shielded by the second light blocking layer 202, dark regions caused by the electric field region of the gate line may be prevented.

In the display panel according to an embodiment of the present disclosure, the color film layer 111 and the light blocking layer are transferred to the thin film transistor array substrate, so that a problem that the display panel with the high pixel density in the prior art has a lower yield rate and a relatively serious color shift at a greater viewing angle due to a greater alignment accuracy error may be effectively solved. In the display panel according to an embodiment of the present disclosure, first, the color film layer 111 and the first light blocking layer are transferred to the thin film transistor array substrate, so that the color film layer 111 and the first light blocking layer may be formed in a precise self-alignment in the same platform. Compared with a solution of aligning the thin film transistor array substrate with the color film substrate disposed with the color film layer in the related art, alignment accuracy may be greatly improved. Meanwhile, the color film layer 111 and the first light blocking layer are transferred to the thin film transistor array substrate, so that the effect of alignment errors between the thin film transistor array substrate and the opposing substrate in the length direction of the gate line on product yield may be eliminated, thereby improving the product yield. Secondly, since the accuracy of the size of the element including a metal or a metal oxide formed by the photomask process and the etching process is greater than the accuracy of the size of the element including a resin formed by the photomask process and the etching process, in an embodiment of the present disclosure, the first light blocking layer is made of a metal or a metal oxide material, so that the shape and the size of the first light blocking layer may be more conformed to the shape and the size of the light-transmitting hole of the mask plate, the line width of the first light blocking layer is less, and the line width uniformity is improved, thereby making the opening of the pixel greater, thereby improving the aperture ratio and improving the display quality of the display panel. In addition, by transferring the color film layer 111 and the first light blocking layer to the thin film transistor array substrate, the optical path difference may be reduced, so that the optical path difference that the light rays pass through the display panel at different viewing angles may be reduced, the color shift at a greater viewing angle may be reduced, and the viewing angle range may be expanded. Finally, since the gate line is shielded by the second light blocking layer 202, dark regions caused by the electric field region of the gate line may be prevented.

Some embodiments of the present disclosure are described in detail above. The above embodiments disclosed in the present disclosure are only a portion of embodiments of the present disclosure and are not intended to limit the scope of the present disclosure. Many variations and modifications will occur to those skilled in the art without departing from the spirit of the present disclosure. Such variations and modifications fall within the scope defined in the attached claims herein.

What is claimed is:

1. A display panel including a thin film transistor array substrate, a liquid crystal layer, and an opposing substrate, wherein the liquid crystal layer is disposed between the thin film transistor array substrate and the opposing substrate;
the thin film transistor array substrate comprises:
a control device layer including a plurality of control devices;
a color film layer disposed on the control device layer, wherein the color film layer includes a plurality of color resist portions of different colors, and two adjacent ones of the plurality of color resist portions having different colors partially overlap each other;
a first planarization layer disposed on a surface of the color film layer close to the opposing substrate;
a first passivation layer disposed on the first planarization layer;
a pixel electrode disposed between the first planarization layer and the first passivation layer;
a first common electrode disposed on the first passivation layer; and
a first light blocking layer disposed on a surface of the first common electrode close to or away from the opposing substrate, wherein the first light blocking layer covers at least an overlapping portion of two adjacent ones of the plurality of color resist portions having different colors and partially overlapping each other.

2. The display panel of claim 1, wherein a second light blocking layer is disposed in the opposing substrate, and a light blocking range of the first light blocking layer is different from a light blocking range of the second light blocking layer.

3. The display panel of claim 2, wherein the control device layer further comprises a plurality of gate lines, the first light blocking layer comprises a plurality of first light blocking strips parallel to each other, and a length direction of the first light blocking strip is perpendicular to a length direction of the gate lines; and
the second light blocking layer includes a plurality of second light blocking strips parallel to each other, and a length direction of the second light blocking strip is parallel to the length direction of the gate line.

4. The display panel of claim 3, wherein a width of the first light blocking strip is less than a width of the second light blocking strip.

5. The display panel of claim 3, wherein an edge of the color resist portion is located within a light blocking range of the first light blocking strip, and the gate line is located within a light blocking range of the second light blocking strip.

6. The display panel of claim 3, wherein in a direction perpendicular to the length direction of the gate line, a first groove is disposed between two adjacent ones of the plurality of color resist portions, and a length direction of the first groove is parallel to the length direction of the gate line;
a second groove is disposed at the first planarization layer, and the second groove is sleeved within the first groove;
a portion of the pixel electrode disposed in the first groove and electrically connected to the control device; and
a portion of the first passivation layer is disposed on a surface of the portion of the pixel electrode located in the first groove.

7. The display panel of claim 6, wherein a second common electrode and a second passivation layer are disposed between the first planarization layer and the first passivation layer, the second common electrode is disposed on the first planarization layer, a portion of the second passivation layer is disposed between the second common electrode and the pixel electrode, and another portion of the second passivation layer is disposed between the second common electrode and the first passivation layer; and
wherein the second common electrode and the second passivation layer are disconnected at the first groove.

8. The display panel of claim 6, wherein a portion of the first common electrode is disposed in the second groove;
the thin film transistor array substrate further includes a second planarization layer, and a portion of the second planarization layer is disposed on a portion of the first common electrode located in the second groove; and
a support member is disposed on a surface of the opposing substrate close to the thin film transistor array substrate, and an end of the support member away from the opposing substrate is in contact with the second planarization layer.

9. The display panel of claim 2, wherein the first light blocking layer has a thickness of 700 angstroms to 2,000 angstroms and the second light blocking layer has a thickness of 10,000 angstroms to 30,000 angstroms.

10. The display panel of claim 2, wherein the first light blocking layer is one of a metal layer and a metal oxide layer or a laminated layer formed by laminating the metal layer and the metal oxide layer, and the second light blocking layer is a resin layer.

11. A display panel including a thin film transistor array substrate, a liquid crystal layer, and an opposing substrate, wherein the liquid crystal layer is disposed between the thin film transistor array substrate and the opposing substrate;
the thin film transistor array substrate comprises:
a control device layer including a light blocking layer, a buffer layer, a semiconductor layer, a gate insulating layer, a gate, a first interlayer insulating layer, a second interlayer insulating layer, a source and a drain, wherein the buffer layer covers the light blocking layer, the semiconductor layer, the gate insulating layer, the gate, the first interlayer insulating layer and the second interlayer insulating layer are stacked on the buffer layer in this order, the source is disposed on the first interlayer insulating layer, and the drain is disposed on the second interlayer insulating layer;
a color film layer disposed on the second interlayer insulating layer and below a first planarization layer, wherein the color film layer includes a plurality of color resist portions of different colors, and two adjacent ones of the plurality of color resist portions having different colors partially overlap each other;
the first planarization layer disposed on a surface of the color film layer close to the opposing substrate;
a first passivation layer disposed on the first planarization layer;
a pixel electrode disposed between the first planarization layer and the first passivation layer;
a first common electrode disposed on the first passivation layer; and
a first light blocking layer disposed on a surface of the first common electrode close to or away from the opposing substrate, wherein the first light blocking layer covers at least an overlapping portion of two adjacent ones of the plurality of color resist portions having different colors and partially overlapping each other.

12. The display panel of claim 11, wherein a second light blocking layer is disposed in the opposing substrate, and a light blocking range of the first light blocking layer is different from a light blocking range of the second light blocking layer.

13. The display panel of claim 12, wherein the control device layer further comprises a plurality of gate lines, the first light blocking layer comprises a plurality of first light blocking strips parallel to each other, and a length direction of the first light blocking strip is perpendicular to a length direction of the gate lines; and
the second light blocking layer includes a plurality of second light blocking strips parallel to each other, and a length direction of the second light blocking strip is parallel to the length direction of the gate line.

14. The display panel of claim 13, wherein a width of the first light blocking strip is less than a width of the second light blocking strip.

15. The display panel of claim 13, wherein an edge of the color resist portion is located within a light blocking range of the first light blocking strip, and the gate line is located within a light blocking range of the second light blocking strip.

16. The display panel of claim 13, wherein in a direction perpendicular to the length direction of the gate line, a first groove is disposed between two adjacent ones of the plurality of color resist portions, and a length direction of the first groove is parallel to the length direction of the gate line;
a second groove is disposed at the first planarization layer, and the second groove is sleeved within the first groove;
a portion of the pixel electrode disposed in the first groove and electrically connected to the control device; and
a portion of the first passivation layer is disposed on a surface of the portion of the pixel electrode located in the first groove.

17. The display panel of claim 16, wherein a second common electrode and a second passivation layer are disposed between the first planarization layer and the first passivation layer, the second common electrode is disposed on the first planarization layer, a portion of the second passivation layer is disposed between the second common electrode and the pixel electrode, and another portion of the second passivation layer is disposed between the second common electrode and the first passivation layer; and
wherein the second common electrode and the second passivation layer are disconnected at the first groove.

18. The display panel of claim 16, wherein a portion of the first common electrode is disposed in the second groove;
the thin film transistor array substrate further includes a second planarization layer, and a portion of the second planarization layer is disposed on a portion of the first common electrode located in the second groove; and
a support member is disposed on a surface of the opposing substrate close to the thin film transistor array substrate, and an end of the support member away from the opposing substrate is in contact with the second planarization layer.

19. The display panel of claim 12, wherein the first light blocking layer has a thickness of 700 angstroms to 2,000 angstroms and the second light blocking layer has a thickness of 10,000 angstroms to 30,000 angstroms.

20. The display panel of claim 12, wherein the first light blocking layer is one of a metal layer and a metal oxide layer or a laminated layer formed by laminating the metal layer and the metal oxide layer, and the second light blocking layer is a resin layer.
